(19) United States
(12) Patent Application Publication
(10) Pub. No.: US 2021/0008710 A1
(43) Pub. Date: Jan. 14, 2021

(54) MOBILE ROBOT

(71) Applicant: Seiko Epson Corporation, Tokyo (JP)

(72) Inventor: Yuki KIYOSAWA, Shiojiri (JP)

(21) Appl. No.: 16/923,222

(22) Filed: Jul. 8, 2020

(30) Foreign Application Priority Data
Jul. 9, 2019 (JP) 2019-127470

(51) Int. Cl. B25J 5/00; B25J 9/00; B25J 17/02; B25J 9/10

(52) U.S. Cl. CPC B25J 5/007; B25J 9/0096; B25J 9/046; B25J 9/1035; B25J 17/0241

(57) ABSTRACT

A mobile robot includes a movable platform including wheels, and a manipulator having a base supported by the movable platform and an arm attached to the base, wherein a base attachment surface to which the base is attached is inclined relative to a movement surface on which the movable platform is to move.

The present application is based on, and claims priority from JP Application Serial Number 2019-127470, filed Jul. 9, 2019, the disclosure of which is hereby incorporated by reference herein in its entirety.

### BACKGROUND

### 1. Technical Field

The present disclosure relates to a mobile robot.

### 2. Related Art

JP-A-2017-74631 discloses a technique, in a manufacturing system including a robot arm and a carriage with the robot arm mounted thereon moving to reciprocate on a workbench, of rotating the carriage around a coordinate axis in a vertical direction in a base coordinate system as a rotation axis.

An actuation space by a manipulator is determined with reference to a base. Accordingly, when one coordinate axis in the base coordinate system is set in the vertical direction of a movable platform, work on an object may be difficult depending on environment.

### SUMMARY

A first embodiment is directed to a mobile robot including a movable platform including wheels, and a manipulator having a base supported by the movable platform and an arm attached to the base, wherein a base attachment surface to which the base is attached is inclined relative to a movement surface on which the movable platform is to move.

A second embodiment is directed to the first embodiment, in which the movable platform has a bottom surface to which the wheels are attached and a top surface opposed to the bottom surface and includes a working board provided on the top surface, and the base attachment surface is inclined relative to the working board.

A third embodiment is directed to the first or second embodiment, in which the movement surface is a horizontal surface.

A fourth embodiment is directed to any one of the first to third embodiments, in which a spacer placed between the base and the movable platform is further provided, wherein the base is supported by the movable platform via the spacer.

A fifth embodiment is directed to the fourth embodiment, in which the spacer has a first surface supported by the movable platform and a second surface forming the base attachment surface.

A sixth embodiment is directed to the fifth embodiment, in which the spacer has an adjustment mechanism that adjusts an angle formed by the first surface and the second surface.

A seventh embodiment is directed to the sixth embodiment, in which the adjustment mechanism includes an adjustment actuator, and adjusts the angle formed by the first surface and the second surface by driving of the adjustment actuator.

An eighth embodiment is directed to the seventh embodiment, in which the adjustment mechanism includes a fixed member and a movable member, the fixed member has the first surface, the movable member has the second surface, the adjustment actuator is attached between the fixed member and the movable member, and the movable member is displaced relative to the fixed member by driving of the adjustment actuator.

### BRIEF DESCRIPTION OF THE DRAWINGS

FIG. 1 is a side view for explanation of a mobile robot according to a first embodiment.

FIG. 2 is a block diagram for explanation of the mobile robot according to the first embodiment.

FIG. 3 is a side view for explanation of an actuation space of the mobile robot.

FIG. 4 is a side view for explanation of the actuation space of the mobile robot according to the first embodiment.

FIG. 5 is a side view for explanation of a mobile robot according to a first modified example of the first embodiment.

FIG. 6 is a side view for explanation of a mobile robot according to a second modified example of the first embodiment.

FIG. 7 is a side view for explanation of a mobile robot according to a third modified example of the first embodiment.

FIG. 8 is a side view for explanation of a mobile robot according to a second embodiment.

FIG. 9 is a side view for explanation of an adjustment mechanism according to the second embodiment.

FIG. 10 is a side view for explanation of an adjustment mechanism according to a first modified example of the second embodiment.

FIG. 11 is a side view for explanation of an adjustment mechanism according to a second modified example of the second embodiment.

FIG. 12 is a side view for explanation of an adjustment mechanism according to a third modified example of the second embodiment.

### DESCRIPTION OF EXEMPLARY EMBODIMENTS

As below, embodiments of the present disclosure will be explained with reference to the drawings. In the drawings, the same or similar elements respectively have the same or similar signs and the duplicated explanation will be omitted.

### First Embodiment

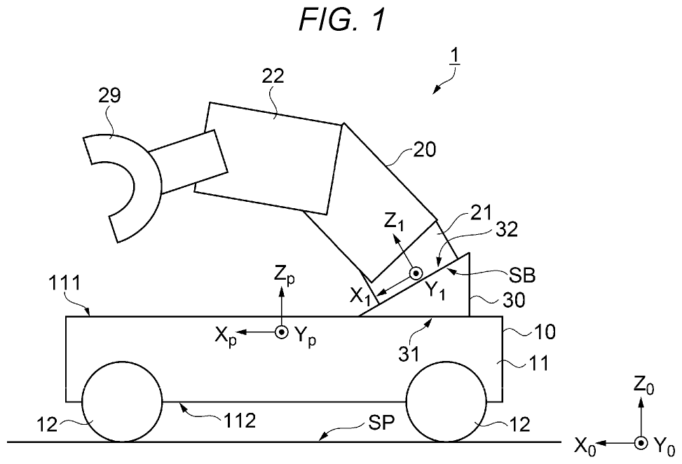

As shown in FIG. 1, a mobile robot 1 according to the first embodiment includes a movable platform 10 and a manipulator 20 having a base 21 supported by the movable platform 10. In the example shown in FIG. 1, the mobile robot 1 includes a spacer 30 placed between the base 21 and the movable platform 10. The base 21 is supported by the movable platform 10 via the spacer 30. For example, the mobile robot 1 moves in a building of a factory, warehouse, or the like and handles objects using the manipulator 20. Accordingly, the mobile robot 1 includes an end effector 29 supported by the manipulator 20 for various kinds of work on the objects. For example, the end effector 29 is a tool such as a gripper, screw driver, or grinder.

The movable platform 10 moves on a movement surface SP. The movement surface SP is a flat surface or horizontal surface on which the mobile robot 1 is placed, e.g. a floor surface. The movable platform 10 may be e.g. an automated guided vehicle (AGV) that travels along a path set on the movement surface SP in advance or an autonomous mobile robot (AMR) that autonomously moves in any direction. The movable platform 10 includes e.g. a main body 11 having a working board on which an object can be mounted and work can be performed, and a plurality of wheels 12 supporting the main body 11. That is, the mobile robot 1 may be a wheeled mobile robot. Or, the mobile robot 1 may be a legged mobile robot, Cartesian coordinate robot, or the like and may move along a rail. The plurality of wheels 12 are attached to a bottom surface 112 of the main body 11. Note that the wheels 12 may be circular parts attached to axles such as tires or caterpillars formed by coupling of steel plates in belt shapes and attached to loop around the front and rear wheels.

A three-dimensional orthogonal coordinate system shown by X₀-Y₀-Z₀ in FIG. 1 is a world coordinate system set for the environment having the movement surface SP. A three-dimensional orthogonal coordinate system shown by Xₚ-Yₚ-Zₚ is a movable platform coordinate system set for the main body 11 of the movable platform 10. In the example shown in FIG. 1, the movable platform coordinate system is set so that the Xₚ-Yₚ plane may be parallel to a top surface 111 of the main body 11. The top surface 111 is parallel to the movement surface SP in a region in which the movable platform 10 is located. In this case, the movement surface SP is parallel to the Xₚ-Yₚ plane of the movable platform coordinate system. Note that the top surface 111 and the bottom surface 112 are opposed in the main body 11.

The manipulator 20 has an arm 22 and the base 21. The arm 22 is e.g. a robotic arm having links and joints coupled to each other and moving at a plurality of degrees of freedom. The arm 22 has e.g. a six-axis arm having six rotary joints. The base 21 sets the origin of the first link, i.e., the link located closest to the movable platform 10 of the arm 22. The base 21 is supported by the spacer 30 on a base attachment surface SB as a joint surface to the spacer 30. The base attachment surface SB is inclined relative to the movement surface SP on which the movable platform 10 is to move.

For example, the spacer 30 is supported by the movable platform 10 on the top surface 111 of the main body 11. The spacer 30 has a first surface 31 facing the movable platform 10 and a second surface 32 forming the base attachment surface SB. That is, the angle formed by the movement surface SP and the base attachment surface SB is defined by the angle formed by the first surface 31 and the second surface 32. The spacer 30 has e.g. a prismatic shape in which the first surface 31 and the second surface 32 form two adjacent side surfaces.

A three-dimensional orthogonal coordinate system shown by X₁-Y₁-Z₁ in FIG. 1 is a base coordinate system set for the base attachment surface SB. The base coordinate system is set so that the Z₁ axis may be orthogonal to the base attachment surface SB. That is, the angle formed by the Xₚ-Yₚ plane and the X₁-Y₁ plane is defined by the angle formed by the first surface 31 and the second surface 32.

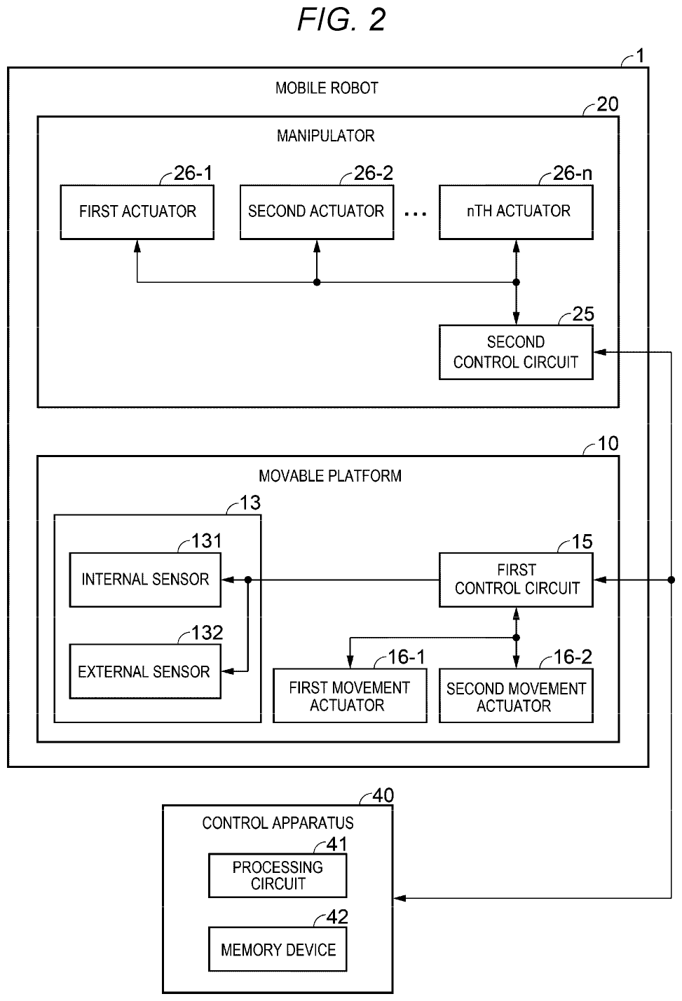

As shown in FIG. 2, the mobile robot 1 is controlled by a control apparatus 40. The control apparatus 40 includes a processing circuit 41 and a memory device 42 forming a computer system. The control apparatus 40 can be configured using e.g. various general-purpose computers. The processing circuit 41 controls the mobile robot 1 by executing commands according to control programs. The processing circuit 41 is e.g. a central processing unit (CPU). The memory device 42 is a computer-readable recording medium that stores the control programs, various kinds of data, etc. necessary for control of the mobile robot 1. The memory device 42 is e.g. a semiconductor memory. Part or all of the component elements of the control apparatus 40 may be placed inside of the housing of the mobile robot 1.

The movable platform 10 includes a sensor unit 13, a first control circuit 15, a first movement actuator 16-1, and a second movement actuator 16-2. The sensor unit 13 is e.g. an internal sensor 131 that measures a state inside of the movable platform 10 and an external sensor 132 that measures a state relating to the environment of the movable platform 10. The internal sensor 131 is e.g. an encoder that measures rotation angles of the first movement actuator 16-1 and the second movement actuator 16-2 making rotational motion, an inertial sensor that measures the velocity or angular velocity of the main body 11, or the like. The external sensor 132 is e.g. an image sensor, range sensor, or the like. Hereinafter, the first movement actuator 16-1 and the second movement actuator 16-2 may be simply referred to as “movement actuators”.

The first control circuit 15 includes a computer system having a processor and a memory and various peripheral circuits. The first control circuit 15 drives the first movement actuator 16-1 and the second movement actuator 16-2 according to output of the sensor unit 13 and control by the control apparatus 40.

The first movement actuator 16-1 and the second movement actuator 16-2 are e.g. motors that respectively drive the pair of wheels 12 placed to rotate about the single axle. In this case, the first movement actuator 16-1 and the second movement actuator 16-2 rotate the pair of wheels 12 in the same direction at the same velocity with each other, and thereby, move the main body 11 in one direction, e.g. the X-axis direction. Further, the first movement actuator 16-1 and the second movement actuator 16-2 adjust balance of the rotation direction and the rotation velocity between the pair of wheels 12, and thereby, changes the orientation on the Xₚ-Yₚ plane, i.e., an angle of traverse about the Zₚ axis of the main body 11. The configurations of the movement actuators are not limited to the above described configurations, but e.g. an actuator that changes a steering angle may be further provided or three or more actuators may be provided.

The manipulator 20 includes a first actuator 26-1, a second actuator 26-2, . . . , an nth actuator 26-n, and a second control circuit 25. Hereinafter, the first actuator 26-1, the second actuator 26-2, . . . , and the nth actuator 26-n are simply referred to as “plurality of actuators 26”. That is, n is an integer equal to or larger than two. A plurality of joints of the manipulator 20 are driven by the plurality of actuators 26, and thereby, a pose of the manipulator 20 is determined.

The second control circuit 25 includes a computer system having a processor and a memory and various peripheral circuits. The second control circuit 25 drives the plurality of actuators 26 and the end effector 29 according to the respective rotation angles of the plurality of actuators 26 measured by a plurality of encoders (not shown) and control by the control apparatus 40.

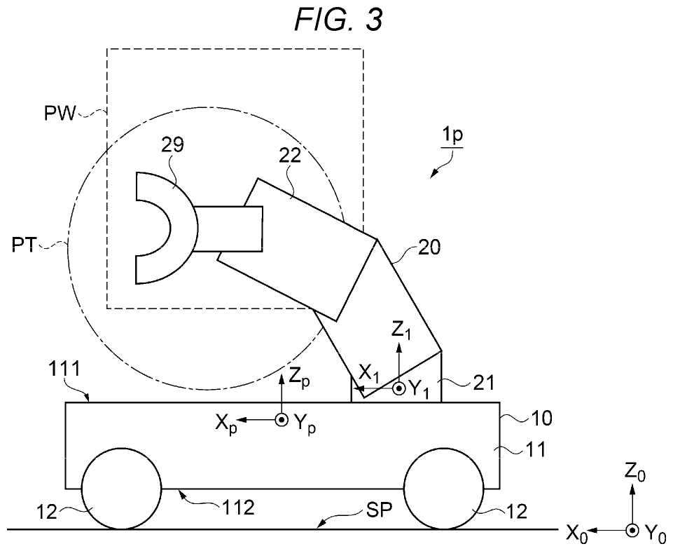

As shown in FIG. 3, a mobile robot 1p without the spacer 30 includes e.g. the movable platform 10 and the manipulator 20 having the base 21 supported by the top surface 111 of the movable platform 10. The base attachment surface of the mobile robot 1p is parallel to the movement surface SP. That is, when the movement surface SP is parallel to the X₀-Y₀ plane, the Z₀ axis, the Zₚ axis, and the Z₁ axis are parallel to one another.

For example, it is assumed that a target space PT of work by the manipulator 20, specifically, the end effector 29 of the mobile robot 1p is a space near the top surface 111, i.e., a space at a predetermined distance above from the top surface 111. An actuation space PW of the manipulator 20 of the mobile robot 1p overlaps with the upper part of the target space PT. The actuation space PW is e.g. a space that may be swept by a reference point set at the distal end of the manipulator 20 in the base coordinate system. The actuation space PW does not overlap with the lower part of the target space PT, and it is understood that work by the manipulator 20 in the lower part of the target space PT is impossible.

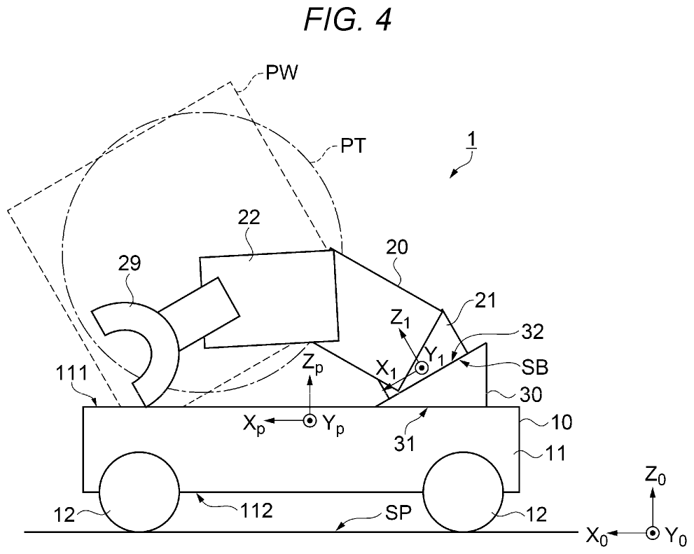

On the other hand, as shown in FIG. 4, the mobile robot 1 includes the spacer 30, and thereby, the base attachment surface SB is inclined relative to the movement surface SP. That is, the Z₁ axis is inclined relative to the Z₀ axis and the Zₚ axis. Thereby, compared to the case shown in FIG. 3, the amount of overlap of the actuation space PW with the target space PT increases and the space in which work by the manipulator 20 can be performed increases.

Generally, the actuation space of the manipulator is determined by the mechanical structure of the manipulator and fixed relative to the base. Accordingly, work by the manipulator mounted on the movable platform may be difficult depending on the relative position of the target space. On the other hand, in the mobile robot 1, the base attachment surface SB is inclined relative to the movement surface SP, and thereby, the actuation space PW of the manipulator 20 may be displaced relative to the movable platform 10. Therefore, the amount of overlap of the actuation space PW with the target space PT can be increased and general versatility of the manipulator 20 may be improved.

Further, generally, the actuation space of the manipulator may be fixed to a region except the vicinity of the base. That is, work in the vicinity of the base may be difficult. On the other hand, in the mobile robot 1, the top surface 111 of the main body 11 can be used as a part of the actuation space PW by mounting of the objects thereon, for example. In the example shown in FIG. 4, the base attachment surface SB is inclined relative to the movement surface SP to bring the actuation space PW closer to the top surface 111 of the movable platform 10 compared to the case without the spacer 30. Thereby, the actuation space PW of the manipulator 20 may be displaced relative to the movable platform 10 and the general versatility of the mobile robot 1 may be improved.

### First Modified Example

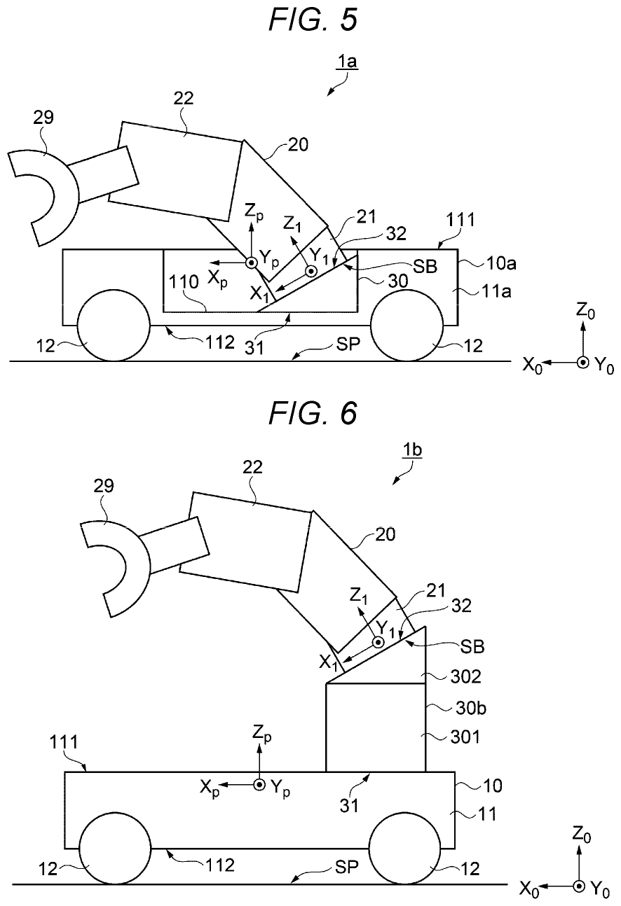

As shown in FIG. 5, a mobile robot 1a according to the first modified example of the first embodiment is different from that of the above described first embodiment in that a main body 11a having a recessed portion 110 opening in the top surface 111 is provided in a movable platform 10a or the like. The configurations, operations, and effects not to be described in the following modified examples are the same as those of the above described embodiment and omitted to avoid duplication.

The spacer 30 of the mobile robot 1a has a first surface 31 supported by the bottom surface of the recessed portion 110 and a second surface 32 forming the base attachment surface SB. Accordingly, the first surface 31 is located below, in the −Zₚ direction in level with reference to the top surface 111. The shape of the recessed portion 110 is determined not to overlap with paths that can be taken by the manipulator 20. According to the configuration, the actuation space PW of the manipulator 20 may be displaced to further below compared to that of the above described first embodiment.

### Second Modified Example

As shown in FIG. 6, a mobile robot 1b according to the second modified example of the first embodiment is different from that of the above described first embodiment in that a spacer 30b having a higher height than the spacer 30 is provided. For example, the spacer 30b has a base spacer 301 having an upper surface and a lower surface parallel to each other and an attachment spacer 302 supported by the upper surface of the base spacer 301.

The base spacer 301 has a first surface 31 supported by the top surface 111 of the movable platform 10 as a lower surface. The attachment spacer 302 has a lower surface supported by the upper surface of the base spacer 301 and a second surface 32 forming the base attachment surface SB. The attachment spacer 302 may have a structure equal to that of the spacer 30 in the above described first embodiment. That is, the base attachment surface SB is inclined relative to the movement surface SP. According to the configuration, the actuation space PW of the manipulator 20 may be displaced above compared to that of the above described first embodiment.

### Third Modified Example

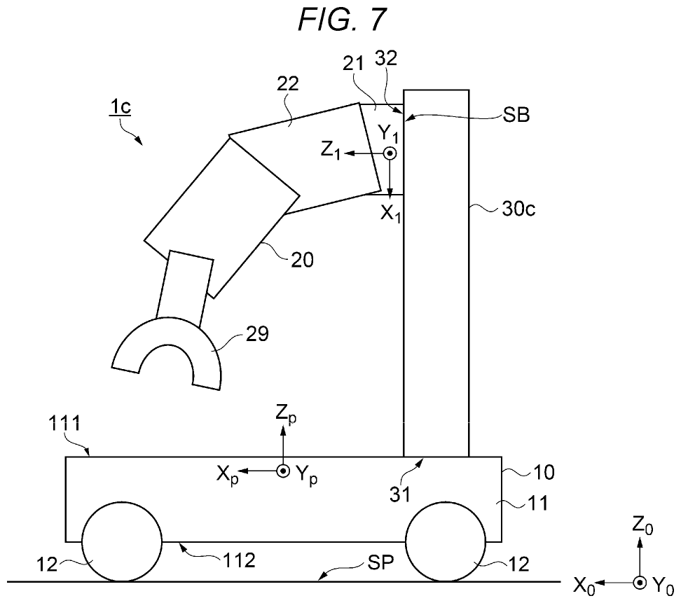

As shown in FIG. 7, a mobile robot 1c according to the third modified example of the first embodiment is different from that of the above described first embodiment in that the base attachment surface SB is orthogonal to the movement surface SP. That is, an inclination angle formed by the base attachment surface SB and the movement surface SP may include 90°. A spacer 30c of the mobile robot 1c has a first surface 31 supported by the top surface 111 of the movable platform 10 and a second surface 32 forming the base attachment surface SB orthogonal to the first surface 31. Thereby, the actuation space PW of the manipulator 20 may be further displaced compared to that of the above described first embodiment.

### Fourth Modified Example

A mobile robot according to a fourth modified example of the first embodiment is different from that of the above described first embodiment in that at least a part of the top surface of the main body of the movable platform is inclined relative to the movement surface. In this regard, the top surface includes the base attachment surface. Accordingly, the base attachment surface can be inclined relative to the movement surface without a spacer provided between the base and the main body. Thereby, the mechanism of the mobile robot is simplified compared to that of the above described first embodiment and manufacturing is easier. Further, the mobile robot may be downsized compared to that of the above described first embodiment.

### Second Embodiment

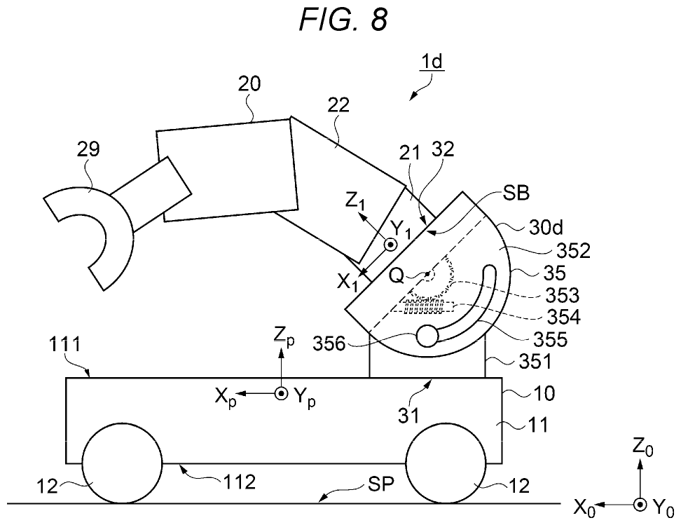

As shown in FIG. 8, a mobile robot 1d according to the second embodiment is different from that of the above described first embodiment in that a spacer 30d has an adjustment mechanism 35 that adjusts the angle formed by the first surface 31 and the second surface 32. The configurations, operations, and effects not to be described in the second embodiment are the same as those of the above described embodiment and omitted.

The adjustment mechanism 35 includes e.g. a fixed member 351 relatively fixed to the main body 11 and a movable member 352 rotating about a rotation axis Q relatively fixed to the fixed member 351. For example, the fixed member 351 has a first surface 31 facing the top surface 111 as a lower surface. The movable member 352 has a second surface 32 forming the base attachment surface SB as an upper surface. The movable member 352 has a slit 355 provided in an arc shape of a circle around the rotation axis Q. The movable range of the movable member 352 is restricted by a stopper 356 provided in the fixed member 351 located inside of the slit 355. Or, the inclination angle of the movable member 352 may be fixed by fastening of the stopper 356 by a screw.

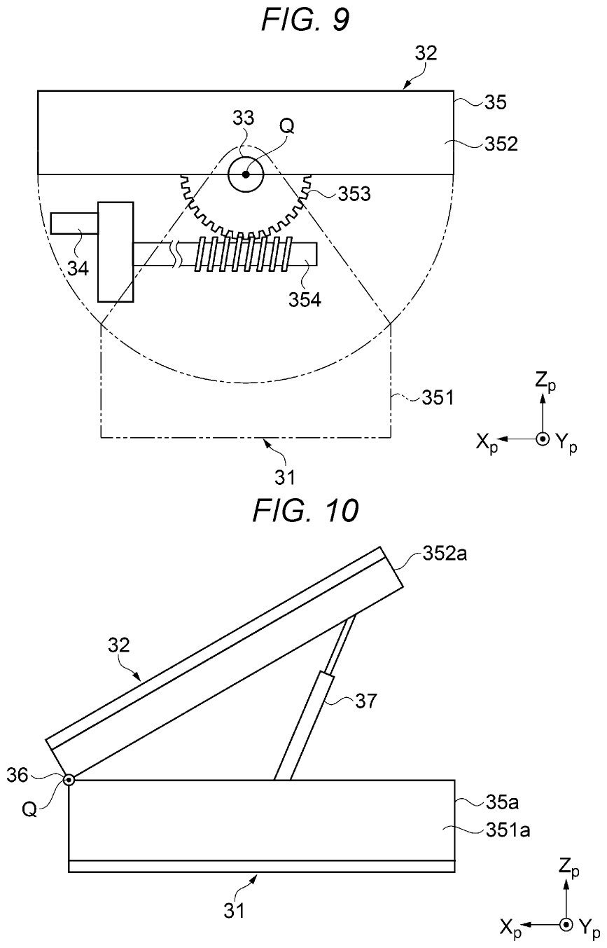

As shown in FIG. 9, the adjustment mechanism 35 includes e.g. a worm gear having a worm wheel 353 and a worm 354 meshing with the worm wheel 353. The movable member 352 and the worm wheel 353 are fixed to each other. The adjustment mechanism 35 has a rotation shaft 33 passing through the center of the worm wheel 353 and defining the rotation axis Q. The rotation shaft 33 is supported by a pair of bearings provided in the fixed member 351. The worm 354 rotates according to e.g. an operation on a handle 34 by a user. Thereby, the angle formed by the first surface 31 and the second surface 32 is adjusted.

### First Modified Example

As shown in FIG. 10, an adjustment mechanism 35a according to the first modified example of the second embodiment is different from that of the above described second embodiment in that a fixed member 351a and a movable member 352a rotating about a rotation axis Q fixed to an end portion of the fixed member 351a or the like. For example, the fixed member 351a has a first surface 31 supported by the top surface 111 (not shown in FIG. 10) as a lower surface. The movable member 352a has a second surface 32 forming the base attachment surface SB (not shown in FIG. 10) as an upper surface.

The fixed member 351a is coupled to the movable member 352a via a hinge 36 provided in an end portion in a planar pattern as seen from the Zₚ direction. The hinge 36 defines the rotation axis Q. For example, the movable member 352a may rotate about the rotation axis Q to open and close the upper surface of the fixed member 351a. The movable member 352a is driven by a power cylinder 37 provided between the fixed member 351a and the movable member 352a via e.g. a link mechanism (not shown). The power cylinder 37 is e.g. an adjustment actuator that changes energy input according to an operation on a handle (not shown) into linear motion. The power cylinder 37 may be selected from e.g. an electric cylinder, oil hydraulic cylinder, gas pressure cylinder, hydraulic cylinder, etc. As described above, the adjustment mechanism 35a adjusts the angle formed by the first surface 31 and the second surface 32 by driving of the adjustment actuator. The adjustment actuator may be controlled by the control apparatus 40 or controlled by another control apparatus than the control apparatus 40.

### Second Modified Example

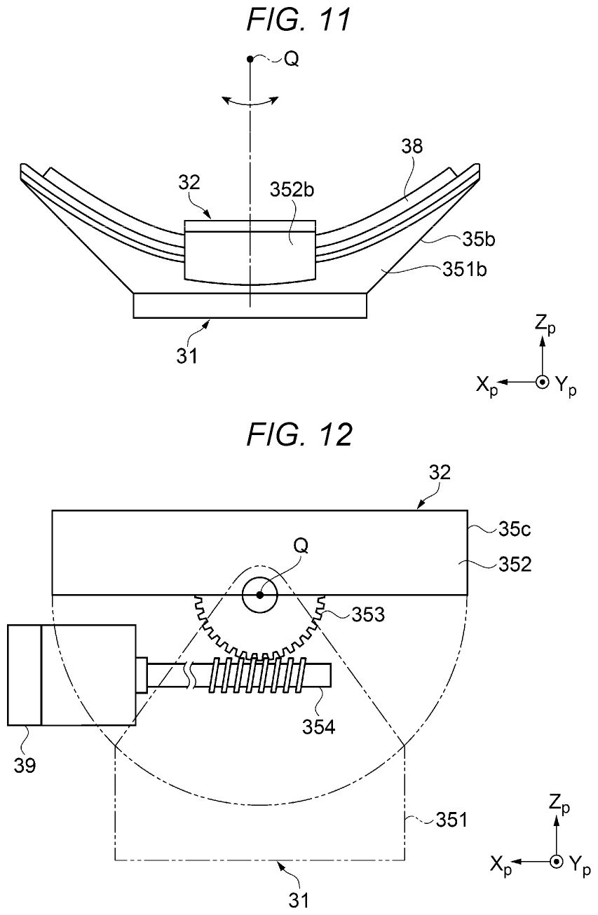

As shown in FIG. 11, an adjustment mechanism 35b according to the second modified example of the second embodiment is different from that of the above described second embodiment in that a fixed member 351b and a movable member 352b rotating about a rotation axis Q relatively fixed to the fixed member 351b above the fixed member 351b are provided or the like.

The fixed member 351b has a first surface 31 supported by the top surface 111 (not shown in FIG. 11) as a lower surface. The movable member 352b has a second surface 32 forming the base attachment surface SB (not shown in FIG. 11) as an upper surface. The fixed member 351b has e.g. a pair of guide rails 38 provided in an arc shape of a circle around the rotation axis Q. The movable member 352b is guided by the guide rails 38 to rotate about the rotation axis Q. The movable member 352b may be positioned in an arbitrary position on the guide rails 38 and fixed by a fixing tool (not shown). Thereby, the angle formed by the first surface 31 and the second surface 32 is adjusted. The adjustment mechanism 35b may adjust the angle formed by the first surface 31 and the second surface 32 by the movable member 352b displaced according to driving of the actuator.

### Third Modified Example

As shown in FIG. 12, an adjustment mechanism 35c according to the third modified example of the second embodiment is different from that of the above described second embodiment in that the worm 354 is rotated by a motor 39. The motor 39 is e.g. an actuator driving of which is controlled by the control apparatus 40. The adjustment mechanism 35c may adjust the angle formed by the first surface 31 and the second surface 32 by driving of the actuator.

### Other Embodiments

The embodiments are described as above, and the present disclosure is not limited to these disclosures. The configurations of the respective parts may be replaced by arbitrary configurations having the same functions, and arbitrary configurations in the respective embodiments may be omitted or added within the technical scope of the present disclosure. From these disclosures, various alternative embodiments will be clearly understood by those skilled in the art.

For example, in the above described respective embodiments, the control apparatus 40 may be omitted. That is, the first control circuit 15 and the second control circuit directly communicate, and thereby, mutually controls driving of the movable platform 10 and the manipulator 20. The movable platform 10 and the manipulator 20 are not necessarily controlled in relation to each other, but may be independently controlled. In the above described embodiments, the example in which the manipulator 20 is the robotic arm is explained, however, the manipulator 20 may be a machine formed by a series of members coupled to each other and relatively rotating or linearly moving. That is, the degree of freedom of the manipulator 20 may be one. The sensor unit 13 may have a configuration without the external sensor 132. The movable member 352 of the adjustment mechanism 35 may not necessarily rotate about the rotation axis Q. For example, the adjustment mechanism 35 may be a link mechanism having a plurality of degrees of freedom. Or, in the example shown in FIG. 11, the guide rails 38 may have another shape than the arc shape of the circle around the rotation axis Q.

In addition, it is obvious that the present disclosure includes various embodiments not described as above, but having configurations applying the above described respective configurations to one another. The technical scope of the present disclosure is defined only by subject matters according to the appended claims reasonable from the above explanations.

As below, the details derived from the above described embodiments will be described as the respective embodiments.

A first embodiment is directed to a mobile robot including a movable platform including wheels, and a manipulator having a base supported by the movable platform and an arm attached to the base, wherein a base attachment surface to which the base is attached is inclined relative to a movement surface on which the movable platform is to move. According to the first embodiment, an actuation space of the manipulator may be displaced relative to the movable platform, and general versatility of the mobile robot may be improved.

A second embodiment is directed to the first embodiment, in which the movable platform has a bottom surface to which the wheels are attached and a top surface opposed to the bottom surface and includes a working board provided on the top surface, and the base attachment surface is inclined relative to the working board. According to the second embodiment, the actuation space may be displaced relative to the movable platform. Thereby, the working board may be set in a target space for work.

A third embodiment is directed to the first or second embodiment, in which the movement surface is a horizontal surface. According to the third embodiment, the mobile robot moving on the horizontal surface may be realized.

A fourth embodiment is directed to any one of the first to third embodiments, in which a spacer placed between the base and the movable platform is further provided, wherein the base is supported by the movable platform via the spacer. According to the fourth embodiment, the mobile robot includes the spacer, and thereby, the base attachment surface may be easily inclined relative to the movement surface.

A fifth embodiment is directed to the fourth embodiment, in which the spacer has a first surface supported by the movable platform and a second surface forming the base attachment surface. According to the fifth embodiment, the spacer that easily inclines the base attachment surface relative to the movement surface may be realized.

A sixth embodiment is directed to the fifth embodiment, in which the spacer has an adjustment mechanism that adjusts an angle formed by the first surface and the second surface. According to the sixth embodiment, an inclination angle of the base attachment surface relative to the movement surface may be adjusted.

A seventh embodiment is directed to the sixth embodiment, in which the adjustment mechanism includes an adjustment actuator, and adjusts the angle formed by the first surface and the second surface by driving of the adjustment actuator. According to the seventh embodiment, the inclination angle of the base attachment surface relative to the movement surface may be easily adjusted.

An eighth embodiment is directed to the seventh embodiment, in which the adjustment mechanism includes a fixed member and a movable member, the fixed member has the first surface, the movable member has the second surface, the adjustment actuator is attached between the fixed member and the movable member, and the movable member is displaced relative to the fixed member by driving of the adjustment actuator. According to the eighth embodiment, the actuation space may be easily displaced relative to the movable platform.

What is claimed is:

1. A mobile robot comprising:
a movable platform including wheels; and
a manipulator having a base supported by the movable platform and an arm attached to the base, wherein
a base attachment surface to which the base is attached is inclined relative to a movement surface on which the movable platform is to move.

2. The mobile robot according to claim 1, wherein
the movable platform has a bottom surface to which the wheels are attached and a top surface opposed to the bottom surface and includes a working board provided on the top surface, and the base attachment surface is inclined relative to the working board.

3. The mobile robot according to claim 1, wherein
the movement surface is a horizontal surface.

4. The mobile robot according to claim 1, further comprising a spacer placed between the base and the movable platform, wherein
the base is supported by the movable platform via the spacer.

5. The mobile robot according to claim 4, wherein
the spacer has a first surface supported by the movable platform and a second surface forming the base attachment surface.

6. The mobile robot according to claim 5, wherein
the spacer has an adjustment mechanism that adjusts an angle formed by the first surface and the second surface.

7. The mobile robot according to claim 6, wherein
the adjustment mechanism includes an adjustment actuator, and adjusts the angle formed by the first surface and the second surface by driving of the adjustment actuator.

8. The mobile robot according to claim 7, wherein
the adjustment mechanism includes a fixed member and a movable member,
the fixed member has the first surface,
the movable member has the second surface,
the adjustment actuator is attached between the fixed member and the movable member, and
the movable member is displaced relative to the fixed member by driving of the adjustment actuator.
